(19) United States
(12) Patent Application Publication
(10) Pub. No.: US 2026/0193801 A1
(43) Pub. Date: Jul. 9, 2026

(54) Carbonous Gas Conversion System

(71) Applicant: Brock Tyler Horstman, Salem, OH (US)

(72) Inventor: Brock Tyler Horstman, Salem, OH (US)

(21) Appl. No.: 19/435,634

(22) Filed: Dec. 29, 2025

Related U.S. Application Data
(63) Continuation-in-part of application No. 18/310,067, filed on May 1, 2023.

(51) Int. Cl. C25B 15/08; B01D 53/22; B01D 53/26; B01D 53/34; B01D 53/62; B01D 53/92; C25B 1/04; C25B 15/02; F02M 27/04

(52) U.S. Cl. CPC C25B 15/081; B01D 53/229; B01D 53/268; B01D 53/346; B01D 53/62; B01D 53/92; C25B 1/04; C25B 15/02; C25B 15/083; F02M 27/04; B01D 2257/504; B01D 2258/01

(57) ABSTRACT

An apparatus utilizing Carbonous Gas Source(s) to produce useful Invention Product which can be reused. Carbonous Gases or their components are diverted to optional device(s), which achieve optimizable effects to enable the apparatus to function as the prior design intended or better to optimize the system's purposes and create added product(s). This to make up for any power loss caused by adding the other devices that make up the apparatus, to produce extra power, increase efficiency and/or longevity compared to the original system design. Various options exist when configuring the invention for a planned system design so as to cater for differing and varying applications, therefore, not all sections of this patent must necessarily be used together and can be customized to the owner/operator's intentions.

Accordingly, this patent covers all possible arrangements and configurations of the concepts and devices described herein for any applications for which the patent is suitable.

### BACKGROUND OF THE INVENTION

The present invention pertains to air conditioning equipment for Carbonous Gas Source systems, across multiple applications and in various fields, for Carbon Dioxide sequestration and conversion.

The prior art consists of more basic filtration systems such as Shanks, et al., U.S. Pat. No. 6,402,811 B1, Campbell, et al., U.S. Pat. No. 6,644,515 B1, and Cabello et al., US 2021/0322907 A1 in the generalized air conditioning systems by which one could sequester Carbon in various formats. These systems aren't specifically using nature-sourced and therefore raw materials that are economically more feasible for using directly with the combustion engine in a vehicle, or other Carbonous Gas Sources, no prior art recycles the processed fumes for increased performance, and no prior art maximizes the Invention Products potentially made available by use of this invention, all while being adaptable, wide ranging, convenient, controllable, mobile, and profitable. Therefore, no prior art is efficient enough such that it would be feasible and worthwhile to use on a plurality of Carbonous Gas Sources in this invention's customizable ways,

Also, there is no compensation for the added restrictions to combustion engine breathing and therefore power loss from using said systems or similar air conditioning systems and therefore restricting all types of Carbonous Gas Source systems due to their addition, this for capturing Carbon Dioxide (the primary greenhouse gas), so rather than empowering them, it reduces the engine's, or Carbonous Gas source's, performance on the prior art, unlike this invention.

The systems stated above also don't create by use of their systems a pre-processed and redistributable product(s) that can then be used directly or secondarily processed to specifically supply other industries nor make the owner/operator money and/or savings in return by creating a new product from the Carbon sequestration process that addresses various demands for said products in the marketplace.

Also, said systems already in existence do not compare to the convenience nor adaptability of said invention as other systems don't have a potential plurality of control systems for each separate system within it to operate and monitor themselves independently within the greater system its applied to, optionally remotely from a separate application, nor supply labor or robotics in their plurality by which to service or replace said systems and product in a fast and uninterrupted manner with which the systems of this invention function. As well, the prior art doesn't come close in level of convenience in regards to how they don't have separate devices that can be separately replaced, serviced, used or done without altogether in any subjective application and regular use of said invention, nor match the multitude of wide ranging applications for which this invention can be applied.

In addition, no other prior art can match the amount of reusable raw materials as Invention Product(s) that this invention can produce, nor match how many potential applications such Invention Product can be reused as such, with a potential for multiple gases and solids being reused in various industries for a variety of applications. Also, no other prior art delivers this type or level of convenient, controllable, wide ranging, variously applying, customizable machinery, nor anything like it that can match its ability to increase power, efficiency, and/or longevity in the machinery or processes that it is used with, as well as causing a more complete and therefore cleaner combustion in the process for more sustainable and eco-friendly brand loyal industry practices.

### BRIEF SUMMARY OF THE INVENTION

The present invention details the Carbonous Gas conversion process applied to Carbonous Gas Sources that harnesses the power of the gases by recycling some but not all of the Water in said gases to enhance the power, efficiency and longevity of the combustion engine or Carbonous Gas Source in said Gas System sources, leading to more complete combustion (or otherwise Carbonous Gas production). This system optimizes said Carbon Sequestering from Carbonous Gas Sources into Invention Products without a limitation of said system from water, heat, pressure or other complications by regulating the parameters applied with one or more control systems and fail-safe mechanisms. This makes said process optimized, convenient, wide ranging, and remotely controlled. The invention's intended product is replaceable from any and all possible applications. As such, this invention also features a general ability to hybridize with various Carbonous Gas Sources in various applications where each device in the system can be utilized or removed for the optimization of the system as a whole so that said invention is significantly optimizing Carbon sequestration and the harvesting of such Invention Product translates at large into mass production and reuse of Invention Product that has wide ranging secondary industrial, commercial and/or personal applications.

No prior art can compare to the level nor combined utility of the use of said machinery described in this patent in the scope of its optimizable, wide ranging, convenient, and controllable capabilities utilizing the Carbonous Gas Source Conversion System that this patent details.

As such, there's no prior art that is as convenient, controllable, variably customizable, wide ranging in its scope, productive of the multiple potential raw substrates it converts into, positive impact on multiple concurrent industries and their subsequent environments, nor as capable of increasing their attached machinery and processes to increase power, efficiency, longevity, smoothness, and cleanness from the more complete combustion that it can cause, and as such, a potentially profoundly important piece of machinery for multiple industries in these regards.

### GLOSSARY

1: “Plumbing”: Any system that conveys fluids for a wide range of applications. Plumbing utilizes, but this list is not limited to: pipes, valves, plumbing fixtures, tanks, and other apparatuses to convey said fluids.
2: “Suitable Plumbing”: Herein means a Plumbing device, or a combination of Plumbing devices, known and proven to be effective in the operation of the invention or parts thereof, and therefore are referred to as part of this patent.
3: “Semi-Permeable Membrane”: A lattice framework and/or mesh material with Hydrophilic properties. These membranes can be used to create a mechanical device which has filtering or separating properties. An example material of this definition would be “MXenes”.
4: “Reactant”: Includes but is not limited to any naturally occurring or man-made compound, material, mixture, and powder, substrate that supports any intended reaction as part or all of the necessary reaction processes required within the invention apparatus.
5: “Reactant Conversion Device”: Any device or devices that orchestrates the Carbon sequestering process within the invention, thereby converting the Carbonous substances within the Carbonous Gases processed by the invention into the intended Invention Products.
6: “Reactant Catalyzing Feature”: Such features require distinct, specific devices that optimize product formation via the potential actions of Reactant mixing, moving, drying, inducing, vibrating, redistributing, rotating, organizing, spreading, shaking, chilling, heating, moistening, magnetizing, rolling, de-clumping, resonating, agitating, stirring, sifting or illuminating by light sources such as LED's, lights, lasers, or otherwise.
7: “Reactant Optimization Device”: Means any device used in an apparatus built to adhere to this patent that may exhibit or utilize one or more Reactant Catalyzing Features or other features which cause greater Carbonous Gas sequestration efficiencies and results.
8: “Reactant Conversion Device Gas Dispersion System”: Any device or devices which act to optimize the sequestration reaction by achieving the more even distribution of the Carbonous Gases throughout the Reactant within a Reactant Conversion Device, achievable by various ways and means, including, but not limited to: gas distribution nozzles or heads, porous tubes, movable jets, graduated holes and adjustable or variable apertures. Said features may be used sequentially, in a plurality, in parallel, individually, in a multiplicity, multi-directionally, or in tandem, but not limited to these possibilities.
9: “Control System(S)”: Means any device or apparatus that controls or monitors other parts

Of the system in various ways and/or reports system condition to the operator so as to achieve and help achieve efficient and effective operation in alignment with the intended functions of this invention.
10: “Hydrophilic”: Not averse to or repelling Water; having an affinity for Water.
11: “Carbonous Gases”: Any and all gases wherein there is a worthwhile extractable amount of Carbon Dioxide, with or without other gases included in such mixtures.
12: “Carbonous Gas Source”: Any gas source(s) that produce Carbonous Gases. These specific gases are a part or all of the gas molecules required for the invention apparatus described herein to operate.
13: “Water”: Any and all conditions of the molecule with two Hydrogen atoms and one Oxygen atom with no more nor less of any single element, this compound normally written as H2O, including but not limited to compounds with synonymous words/phrases used as names, such as “moisture”, “water vapor” or any gas or liquid in which Water is the solution or primary component therein.
14: “Invention Products”: These include, but are not limited to: the compounds Silica, Magnesium Carbonate/Bicarbonate, Iron Carbonate, Carbonate ions and the molecules O2 and H2.
15: “Gas System”: A combustion, gas collection system or device that repurposes the reinjected H2 and/or O2 produced by the Invention which may but doesn't necessarily also feed into a Carbonous Gas Source such as engines, reactors, open flames, stoves, gas tanks or otherwise.

### BRIEF DESCRIPTION OF THE VIEWS OF THE DRAWING

FIG. 1 depicts a potential application of the overall system to, in this case, an internal combustion engine.

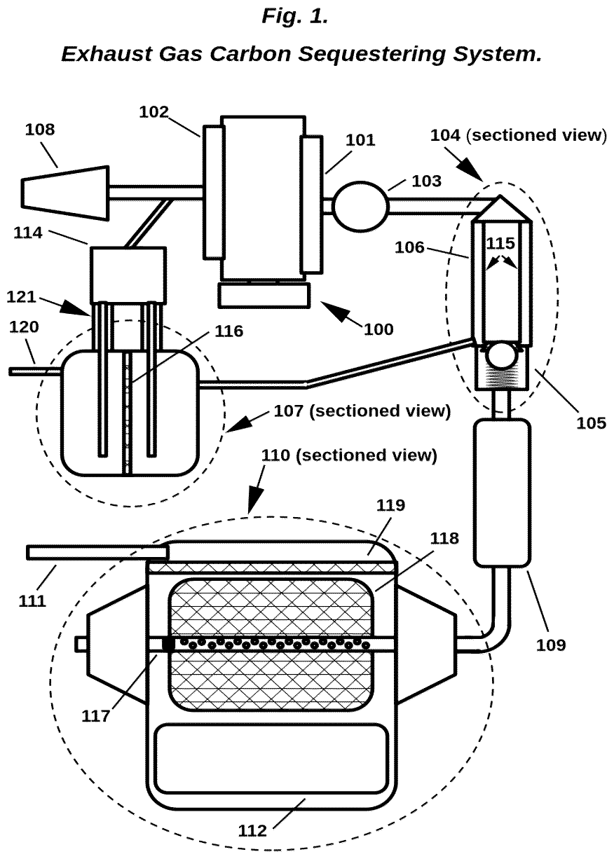

### DRAWING REFERENCE NUMERALS LIST FOR FIG. 1

100. Carbonous Gas Source
101. Internal Combustion Engine—Carbonous Gas Plumbing
102. Internal Combustion Engine—Inlet Plumbing
103. Internal Combustion Engine—Catalytic Converter
104. Invention-Carbonous Gas Dehydration Chamber
105. Invention—Carbonous Gas Dehydration Chamber Pressure Regulator
106. Invention—Water Collection Chamber
107. Invention—Water Electrolysis Device
108. Internal Combustion Engine—Inlet Air Filter
109. Internal Combustion Engine—Carbonous Gas Muffler
110. Invention—Reactant Conversion System
111. Invention—Gas Exit Plumbing
112. Invention—Product Removal Device
114. Invention—Control System
115. Invention—Carbonous Gas Dehydrating Chamber Semi-Permeable Membrane
116. Invention—Water Electrolysis Semi-Permeable Membrane
117. Invention—Reactant Conversion Device Gas Dispersion System
118. Invention—Reactant Conversion Device
119. Invention—Gas Filtration Device
120. Invention—Water Overflow Exit Device
121. Invention—Electrolysis Device Output Plumbing

### DETAILED DESCRIPTION

The apparatus patented here comprises but is not limited to up to distinct device types, each device with a potential for one or more of each device added in tandem or in a series to each combustion engine, engine series, or alternative Carbonous Gas Source(s), these working in unison to achieve the overall goal of the invention: harnessing the Carbon content of Carbonous Gas Source(s) as well as their purified air products. These four devices are the Reactant Conversion System(s) 110, the Carbonous Gas Dehydration Chamber(s) 104, the Water Collection Chamber(s) 106, and the Water Electrolysis Device(s) 107. The Carbonous Gas CO2 produces useful and saleable products including, but not limited to: Magnesium Carbonate/Bicarbonate, Silica, Iron Carbonate and Carbonate ion compounds, as well as O2 and H2 molecules if they choose to store said gases separately instead of reinjecting them into the system or emitting them into the outside air.

The said 4 distinct device types potentially required are described herein, although not all of these devices are always used in any particular, suitable application for the patent, as the processes required for said various applications may vary slightly or significantly depending on which application this invention is applied to. The apparatus connects to the Carbonous Gas Plumbing 101 of a Carbonous Gas Source(s) 100, in a gas and fluid tight way via Suitable Plumbing, that then connects to the entry Plumbing of one or more device(s) containing pressurized Carbonous Gas Dehydration Chamber(s) 104, where said device(s) are required for the application to which it is applied, which is/are pressure regulated using a mechanical or an electromechanical Carbonous Gas Dehydration Chamber(s) Pressure Regulator 105, so that said Carbonous Gas Dehydration Chamber(s) 104 partially dehydrate the Carbonous Gases passing through the system, not dehydrating said gases entirely however, because subsequent sections of the system do or may require some moisture, to operate effectively.

Said Carbonous Gas Dehydration Chamber(s) 104 has a wall lining of Semi Permeable Membrane(s) 115 that allow Water sized molecules through one or more said Membrane(s) 115, but not Carbon Dioxide and similar Carbonous Gas molecules. Said Carbon Dioxide molecule is larger than a Water molecule, so a Membrane(s) 115 mesh size of 300 angstroms, or slightly larger or smaller, will separate the Carbonous Gas Sources, allowing the Water to pass through and the Carbon Dioxide to be separated and therefore said Water content is then diverted through said Membrane(s) 115 to one or more Water Collecting Chamber(s) 106, this separate from the remaining gases and moisture that pass directly through without being diverted.

Said separated Water that collects in said Water Collecting Chamber(s) 106 which is Enclosed like a containing chamber and with Suitable Plumbing to achieve an entry and an exit, plus a secondary Plumbing device, this possibly incorporated in the Water Electrolysis Device(s) 107, this possibly remotely located, that conditionally opens to let out any overflow of Water which is emitted outside, either directly or into a subsequent collection device, via the Water Overflow Exit Device 120. The rest of the said collected Water is forced by pressure difference into one or more Water Electrolysis Device(s) 107 under the control of Suitable Plumbing and possibly required, one or more, Control System(s), such as Control System 114 used as an example. The separating Water Electrolysis Semi-Permeable Membrane 116 is used with any suitable electrical power supply to properly electrolyze the above said Water flow, using Suitable Plumbing & devices in various forms and therefore electrolyze said Water into gases/vapors containing H2 and O2 molecules, which will rise in the Water mixture to the Electrolysis Device output Plumbing 121, this potentially arranged individually for each molecule type, that allows them both to exit separately, or as a gaseous mixture.

The Water Electrolysis Device Output Plumbing 121 of the Water Electrolysis Device(s) 107 connects to the Inlet Plumbing 102 via a suitable, controlled fueling system, such as Control System(s) 114, so as to augment and increase engine performance, due to additional energy released by combustion of the emitted H2 molecules, within the engine(s) or combustion system(s). This part of the system is designed to replace any lost power due to the presence of the Carbonous Gas Dehydration Chamber(s) 104 within the Carbonous Gas Source(s) Plumbing, this benefit due to more efficient combustion, or a larger combustion than usual and therefore more efficient and/or powerful operation overall, because of the additional H2 and O2 molecules introduced to the Inlet Plumbing 102, as said above. If the user of said system would rather store said gases rather than reinject them, the option is present as long as said user owns and properly uses appropriate equipment and attachments in order to store said gases, such as O2 and H2 into gas tanks, for example, or into a different operating system or process, altogether.

Said Carbonous Gas Dehydration Chamber(s) 104 also dehydrates the Carbonous Gas Sources so that the emitted Carbonous Gases have a more optimal ratio of Water compared to CO2, which makes it so that the CO2 will be more convertible before being expelled, that is, so there is a greater total CO2 conversion into product and the efficiency thereof.

The Carbonous Gas Dehydration Chamber(s) 104 has Suitable Plumbing so that the remaining Carbonous Gases are pushed by the usual pumping action of the Carbonous Gas Source(s) 100, including combustion generated pressures within the Carbonous Gas Source(s) Plumbing, then through Suitable Plumbing to the main device of the patent, this including but not limited to one or more filled or partially filled Porous, Reactant Conversion Device(s) 118 containing Reactant such as Olivine or Basalt or similar, so that the resulting chemical conversion can sequester Carbon from the gaseous flow and create a new, usable Invention Product. The rest of the Carbonous Gases then pass through a Porous, Reactant Conversion Device(s) 118, then through a Gas Filtration Device(s) 119 to the Gas Exit Plumbing 111, so that the modified Carbonous Gases are released in a more purified form than is usual, to the outside environment.

Said Reactant Conversion System(s) 110 may alternatively include or utilize other types of Reactant Optimization Device(s), these of a potentially differing design to the above 110, so that the Mixture within is converted more effectively, with said device(s) possibly using the control resources of one or more of the Control System(s), such as 114, of the completed and operating invention, in order to control, regulate and/or manage said Reactant Conversion System(s) 110. See an example of a Reactant Conversion System(s) 110 as depicted in FIG. 1, this figure showing one Reactant Optimization Device(s) option, this being a rotating drum 118 upon which the desired reactant interaction and the subsequent chemical reaction takes place. Incorporated in this option is a Reactant Conversion Device Gas Dispersion System(s) 117 and the Porous, Reactant-Containing Device(s) 118, which is optionally removable for service, including reactant extraction/removal and/or refill, via a Product Removal Device(s) 112. Said Reactant Conversion System(s) 110 may be manufactured with or without included Reactant Catalyzing Feature(s), or other reaction improving methods, substances, features, facilities or arrangements.

A portion of the Control System resources, such as possibly included in one or more Control System(s), with 114 as an example here, may also provide ways and means for the Reactant Conversion System(s) 110 to adapt to non-ideal situations arising within the conversion process and to also adapt to any operating condition the Carbonous Gas System was originally designed for. Said Control System may also monitor various operating factors, including the proportions and amounts of the various reactants within the Reactant Conversion System(s) 110, so as to provide a usage/condition gauging system for operator review. Once at a suitable level of production, the Invention Product can be extracted from the Reactant

Conversion Systems(s) 110 via one or more suitable Product Removal Device(s) 112, for resale or reuse elsewhere.

Said Reactant Conversion System(s) 110 is designed for systems that process or handle Carbonous Gas Sources, this including emissions from combustion engines or combustion systems, these often found in the following plant(s) or equipment, but not limited to: vehicles, automobiles, farming equipment, trains, power stations, maritime/mining applications, environmental control & conditioning equipment, including that for air conditioning, industrial and commercial process plant(s), as well as personal use on domestic heating systems so that the overall system design may vary greatly based on the overall requirements of the system and preferences of its owner/operator.

Apparatus, devices and features utilized by, or operating to, this patent may therefore be of any capacity, size, layout, form, design, arrangement, combination or shape, as is found necessary for effective invention operation.

Nothing about the invention interferes with any required emission control system or other standardly fitted system that the Carbonous Gases emitted are required to be processed by under law or typically, such as a Catalytic Converter(s) 103, Inlet Air Filter(s) 108 and/or Carbonous Gas Muffler(s) 109; however, said pre-existing emissions control system(s) may require necessary recalibrations to be suitable.

1) I claim methods for the utilization of by-products from Carbonous Gas Sources for various uses, where said inventions may be used together, separately or as a mixture thereof, these comprising 3 separate claims, numbered #2, #3 & #4, here:

2) I claim a Water sequestering, Carbonous Gas Source Water separation system that recycles Water for optional reintake by a Gas System, process, or collection, this claim comprising the following 3 subclaims:
2.A) A Carbonous Gas Source dehydration system comprising a pressure regulated chamber which has one or more Water permeable diffusion linings for the removal of Water by pressurized diffusion from the Carbonous Gas flow;
2.B) A related Water collecting chamber connected to a dehydration system chamber For Water collection and reuse;
2.C) A Water electrolyzing chamber, this fed from a Water collecting chamber via suitable plumbing whereby said chamber is fed moisture and separates incoming Water molecules based on demand of Gas System(s), processes or storage system(s) operating load, speed requirement and/or capacity from which further Plumbing then feeds Water vapor as H2 and O2 ions leading to the air inlet and injecting into it for combustion, consumption, processing and/or storage by a Gas System or otherwise connected so as to increase heat, power, operating efficiency, longevity and/or stored amount: ionic separation process being achieved by use of but not limited to a Semi-Permeable Membrane-based device.

3) I claim a Carbonous Gas Source mounted Carbon Dioxide sequestering and converting device that contains within it a reactant, including but not limited to Olivine or Basalt, which reacts readily to CO2 in presence of Water and heat from a Carbonous Gas Source, to create Carbon sequestered product substances(s): product substance(s) are then extracted from a system and reused for other purposes as newly formed and readily redistributed product to be usable for industrial, commercial or personal purposes, this claim including the following sub-claim:
3.A) A related, logistical system which uses equipment and/or labor to remove and reuse product compound(s) of claim #3 for redistribution, reuse, and/or resale to other industries, ventures, enterprises, processes, and/or personal uses.

4) I claim suitable Control System(s) arranged to manage separate functions, features, performances and conditions of equipment required for an overall system as is required to implement above claims.
